(19) United States
(12) Patent Application Publication
(10) Pub. No.: US 2020/0281219 A1
(43) Pub. Date: Sep. 10, 2020

(54) METHOD INVOLVING PEF TREATMENT AND DRYING

(71) Applicant: OPTIFREEZE AB, LUND (SE)

(72) Inventors: Eda DEMIR, LUND (SE); Katarzyna DYMEK, LUND (SE); Federico GOMEZ, LUND (SE); Stephen KWAO, LUND (SE); Allan RASMUSSON, HALLARÖD (SE); Maria Elena VICENTE DAMAS, LUND (SE)

(21) Appl. No.: 16/090,779

(22) PCT Filed: Apr. 4, 2017
(86) PCT No.: PCT/SE2017/050337

§ 371 Date: Oct. 2, 2018

(30) Foreign Application Priority Data
Apr. 4, 2016 (SE) 1650453-2

(51) Int. Cl. A23B 7/015; A23B 7/02; A23L 3/32; A23L 3/40; A23B 7/08; A23L 3/3562

(52) U.S. Cl. CPC A23B 7/015; A23B 7/02; A23L 3/32; A23V 2002/00; A23B 7/085; A23L 3/3562; A23L 3/40

(57) ABSTRACT

The present invention describes a method for treatment of biological soft tissue, said method comprising a step involving pulsed electric field (PEF) treatment to open up the stomata in tissues and a subsequent drying step, wherein the PEF treatment is performed in an electrical field with a field strength in the range of 0.4-1.5 kV/cm to provide enhanced rate of moisture removal during dehydration without irreversible damage on epidermal cells, wherein the PEF treatment is performed with reversible electroporation and wherein the temperature in the drying step is held within the range of 20-55° C.

### FIELD OF THE INVENTION

The present invention relates to a method for treatment of biological soft tissue, involving pulsed electric field (PEF) treatment and drying.

### TECHNICAL BACKGROUND

PEF treatment is known to be used in different industrial application, e.g. in treatment of biological materials. One example is in the food industry for conservation treatment of e.g. orange juice. Another example is disclosed in WO2009/045144, which discloses a freezing method for a plant food product, said method involving applying PEF to the plant food product.

Moreover, drying is an old method of food preservation widely used for such purpose. Drying of plant materials induces structural changes which leads to loss of nutritional value, tissue damage and colour change. Until now, exporters of dried sweet basil leaves face the challenge of low total phenolic contents. This is because the aromatic constituents of herbs and spices are very sensitive to heat, complicating their drying process. Often, the dehydration of herbs and spices is carried out at low temperatures to help preserve most of the volatiles components. A major challenge with the low temperature drying is the slow removal of moisture, leading to long drying times and high-energy consumption. The need to reduce the cost of heat treatment coupled with increased consumer demand for processed products that retain most of the characteristics of the original produce has led to the development of various pre-drying techniques aimed at accelerating the rate of moisture removal.

One aim of the present invention is to provide a method optimal for treatment of a biological soft tissue for the preservation of the same while at the same time conserving aroma in the material.

### SUMMARY OF THE INVENTION

The latter stated purpose above is achieved by a method for treatment of biological soft tissue, said method comprising a step involving pulsed electric field (PEF) treatment to open up the stomata in tissue and a subsequent drying step, wherein the PEF treatment is performed in an electrical field with a field strength in the range of 0.4-1.5 kV/cm to provide enhanced rate of moisture removal during dehydration without irreversible damage on epidermal cells, wherein the PEF treatment is performed with reversible electroporation and wherein the temperature in the drying step is held within the range of 20-55° C.

The present invention is directed to providing reversible and not irreversible electroporation. According to the present invention, it has been found that a field strength in the range of 0.4-1.5 kV/cm is needed to ensure reversible electroporation. Furthermore, reversible electroporation provides a better aroma preservation when being compared to irreversible electroporation.

In relation to the above description, the following may be mentioned as a start. Pulsed electric field (PEF) is a non-thermal pre-treatment technique. As discussed below, this treatment may be performed at different field strengths. The present invention provides an optimal range in a two-step treatment involving both PEF and subsequent drying. This field strength range provides a comparatively gentle treatment so that epidermal and guard cells can be reversible electroporated and enough to keep the stomata opened during the drying process. As such, the present invention provides an optimal treatment of a biological material where drying is performed with a reduced drying time and where also e.g. the aroma is conserved in the biological material, e.g. a herb.

There are known methods where PEF is used for treatment of a biological organic tissue. One example is provided in US 2006/0254912 which discloses a method involving applying a direct current preferably of low voltage electrical field for short duration. In relation to the present invention, the range of voltage suggested differs in comparison to the preferred range of the present invention. Moreover, even if drying is mentioned as one possible combination step in US 2006/0254912, it is not suggested as a subsequent step in a two-step treatment such as according to the present invention.

Furthermore, also in “Direct Current Electrical Field Effects on Intact Plant Organs” (R. Zvitov et al.), Institute of Biochemistry, Food Science and Human Nutrition, and Department of Agricultural Botany, The Hebrew University of Jerusalem, Faculty of Agricultural, Food and Environmental Quality Sciences, there is disclosed a treatment of plant tissue by applying a low DC electrical field. Stomatal opening as a result of the electrical treatment of leaves was observed. The method disclosed is intended as an initial drying or as part of another more drastic drying method. Also in this case the present invention differs with reference to the provision of a clear two-step process combining a first PEF step with a subsequent drying step. Moreover, the electrical field strength used in the article above is not the same as the suggested preferred range as according to the present invention.

### SPECIFIC EMBODIMENTS OF THE INVENTION

Below specific embodiments of the present invention are described. According to one specific embodiment, the stomata is kept open during the PEF treatment and during at least part of the subsequent drying step. The stomata is opened by the PEF treatment as such and then kept during at least part of the drying. The method according to the present invention enables an irreversible treatment of leaves, and the metabolic activity is kept in the leaves. Moreover, the dried but still active leaves can also be rehydrated after the treatment according to the present invention.

According to yet another specific embodiment of the present invention, the stomata is kept open during the entire method, i.e. during both the PEF treatment, which treatment part opens the stomata, and also during the drying part. To keep the stomata open during the whole method according to the present invention is preferred.

Furthermore, according to one specific embodiment of the invention, the PEF treatment is performed so that the metabolic activity is kept when drying to at least a moisture level of 20% moisture content. According to yet another specific embodiment the drying step is maximum performed down to a moisture level of 20% moisture content to keep metabolic activity in the cells. To perform the PEF treatment to ensure a kept metabolic activity at a low level of moisture content when drying, as well as the concept of keeping the stomata open, are not known or used in methods know today.

It should be noted that the drying according to the present invention may be applied so that the humidity reaches levels below 20%. One possible example is when drying basil leaves where the set humidity to reach may be at about 10%. Regardless, the PEF treatment step according to the present invention is applied so that the metabolic activity is sensibly higher that a control sample when drying to 20% humidity. Furthermore, the present invention may also comprise a rehydration step after the drying step. Rehydration results show that PEF treatment prior to drying results in a higher rehydration capacity of the dried product when compared to dehydrated untreated leaves. A focus group discussion carried out by untrained panellists shows that the preference towards PEF treated dried basil is higher than the preference to untreated basil, being noticeably higher when lower drying temperatures are applied. Samples PEF treated and impregnated with hypertonic trehalose solution resulted in higher drying time, lower rehydration capacity and lower sensorial acceptance when compared to only PEF treated leaves.

According to the present invention, the PEF treatment is performed with reversible electroporation. This is preferred when the method according to the present invention is intended for treatment of e.g. herbs. Reversible electroporation implies that the epidermal cell membranes reseal themselves after the treatment while the stomata remain open. This further implies that the aroma inside of the cells is preserved better during the treatment. In relation to this it should be noted that complete cell disruption is not as effective to use as a pre-treatment to enhance the drying rate of herbs since their aromatic constituents will be lost. Plants lose water through opened stomata during growth but the stomata normally gradually close when a plant is cut. According to the present invention it has been observed that reversible electroporation of epidermal cells and opened stomata at low field strength enhanced the rate of moisture removal during drying, such as convective air-drying, of the leaves and the drying time is then reduced considerably. The reduction in drying time as a result of opened stomata electroporation indicates the removal during dehydration without irreversible damage of cell membranes of the cells in the leaves.

As notable from above, the field strength during the PEF treatment is one important parameter according to the present invention. According to the present invention, pulses applied have a field strength in the range of 0.4-1.5 kV/cm. This range is especially suitable for the provision of reversible electroporation. Moreover, according to yet another specific embodiment of the present invention, pulses applied are monopolar pulses having a field strength in the range of 0.6-1.0 kV/cm. Also bipolar pulses are fully possible according to the present invention, then often applied with a field strength in the range of 0.6-1.0 kV/cm.

The range of the field strength according to the present invention has an enhanced effect in terms of providing a gentle but effective PEF treatment for a subsequent drying step.

According to yet another specific embodiment of the present invention, the method also comprises measuring the conductivity. Conductivity starts to increase when electroporation is performed. Therefore, according to the present invention the electric field can be adapted based on the quality of the leaves to be treated.

According to yet another specific embodiment of the present invention, the conductivity is measured after a first pulse and after a last pulse, and wherein the applied field strength is selected so that the conductivity has increased at least 5% between the first pulse and the last pulse. According to yet another specific embodiment, the conductivity has increased at least 10% between the first pulse and the last pulse. To give one example, the method of involving conductivity measurement according to the invention may be performed according to the following:

1. Set the desired treatment parameters, except for the voltage.

### 2. Start at a low E, e.g. 50 V/cm.

3. Treat once and measure the conductivity in the first pulse.
4. Treat once more and measure the conductivity in the last pulse.
5. Increase e-field by 50 V/cm and repeat 3 and 4 until the conductivity has increased more than 10% between no 3 and 4.

There are of course also other parameters of interest for the PEF step in the method according to the present invention. One is pulse width. According to one specific embodiment of the present invention the pulse width being applied is in the range of 80-150 μs.

Another parameter of interest is pulse space. According to one specific embodiment of the present invention, the pulse space being applied is in the range of 500-1000 μs.

In order to get guard cells of the stomata complex electroporated (and have the stomata opened), pulse width and space between pulses is suitably held in a specific range. If not there is an evident risk that you can still get electroporation on epidermal cells but not in the guard cells of stomata.

Furthermore, according to yet another specific embodiment of the present invention, the number of pulses being applied is in the range of 65-300 pulses. Moreover, according to one embodiment, the number of pulse trains is in the range of 1-10. The space between the pulse trains may e.g. be in the range of from 0.1 to 100 s.

The drying step in the method invention is of course also a key step according to the present invention. In general, it is of interest to keep the drying temperature as low as possible, but still to provide enough drying effect. When comparing to a regular drying step, the method according to the present invention provides a reduction of the drying time needed. The effect is enhanced at comparatively lower temperature. For instance, at about room temperature then the reduction of the drying time is around 70%. When using a drying temperature in the range of 40-50° C. then the same reduction is around 30-50%.

Furthermore, there is also another link between the PEF step and the drying step. When the field strength is increased, up to irreversible conditions, the drying time is being reduced. As disclosed above, this is totally fine in some applications, however when conserving herbs this is not the case. As discussed above, irreversible conditions provide a greater loss of aroma.

According to the present invention, the temperature in the drying step is held within the range of 20-55° C. According to one preferred embodiment of the present invention, the temperature in the drying step is held within the range of 20-50° C.

As disclosed above, the reduction in drying time is greater at comparatively lower temperature. If such temperatures are possible for a specific industrial application they are preferred. Therefore, according to one embodiment, the temperature in the drying step is held within the range of from room temperature to 50° C., such as from room temperature up to 40° C. Room temperature is as normally defined a temperature in the range of 20-25° C., often stated as 21° C.

All types of drying and use of dryer types are possible according to the present invention. According to one specific embodiment, convective air-drying performs the drying. Convective air-drying has proven to be an effective means for drying according to the present invention.

The present invention may also comprise other steps of action. According to one specific embodiment of the present invention, the method also involves a vacuum impregnation step. Vacuum impregnation (VI) of solutes (cell protecting agents) with known biological membrane preservation properties have been shown to protect cellular tissue during air drying and improve rehydration properties of plant tissue. As notable below, a first step of vacuum impregnation may decrease the needed level of electrical field strength to obtain stomata opening during the subsequent PEF step.

The figures provide several trials in which also vacuum impregnation has been used. It should be noted that vacuum impregnation is normally performed as a step before the PEF step according to the present invention however it may also be executed as a step after the PEF step. When vacuum impregnation is used as a pre-treatment step before PEF treatment the drying time may be reduce even further according to the present invention. As an example, with one trial with parsley when vacuum impregnation was performed with fructose and PEF treatment was performed subsequently, then the reduction in drying time was 68% as compared to 38% when only PEF was applied. This is valid for some products, such as thyme and parsley, but may not be true for all.

As mentioned above, the method according to the present invention may find use in several different industrial applications. One suitable application according to the present invention is for the conservation of aroma in an herb. The present invention provides a method, which provides enhanced rate of moisture removal during dehydration without irreversible damage of the cell membrane and which provides enhanced conservation of aroma in dried herbs. Dried herbs of interest are many, and some examples are given in the description to the figures, e.g. basil and dill. Other examples of interest are parsley, oregano, rosemary and thyme.

### EXAMPLES AND DESCRIPTION OF THE DRAWINGS

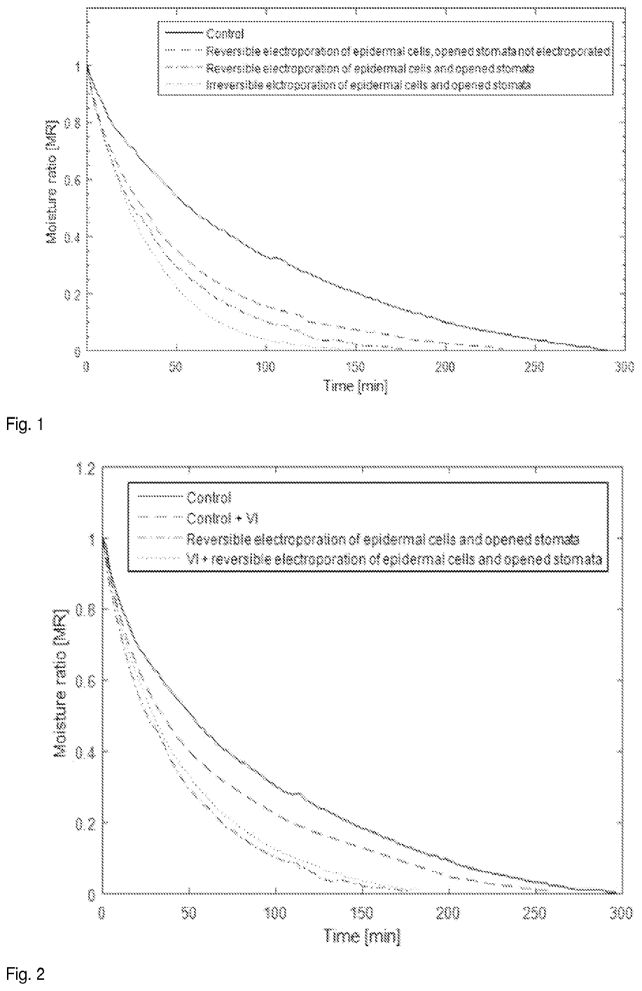

In FIG. 1 there is shown graphs on the effect of PEF parameters on the convective air-drying of basil leaves. Convective drying of the samples was carried out at 50° C. and 2 m/s air velocity. Both samples were exposed to light for 1 h and either immediately dried (control) or PEF-treated before drying.

In FIG. 2 there is shown graphs on the combined effect of vacuum infusion (VI) with trehalose and PEF treatment on the convective air-drying of basil leaves.

It should be noted that FIGS. 1 and 2 show background examples showing the effects discussed above, and not graphs on trials performed within the evaluation work of the present invention.

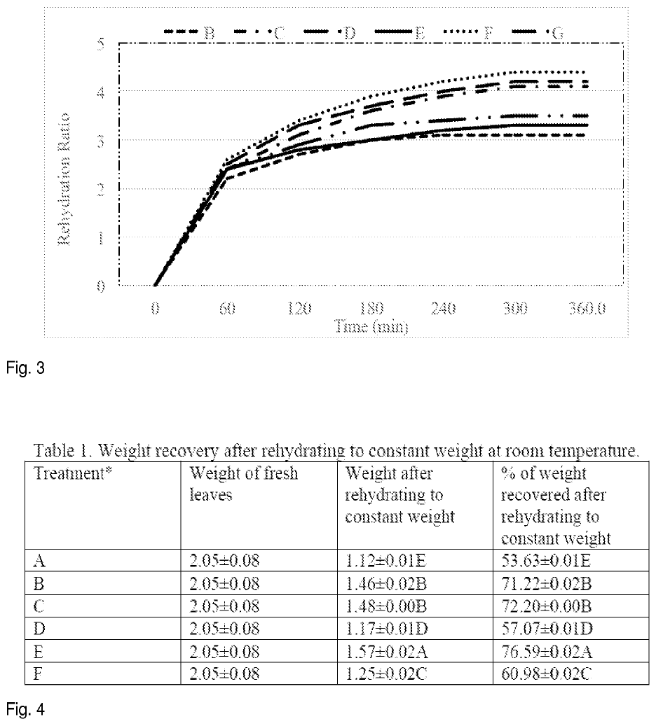

Furthermore, in FIG. 3 there is shown graphs showing the variation of rehydration ratio with time. The following treatments are shown: (B) The control (untreated), (C) Reversibly electroporation with opened stomata not electroporated, (D) Reversible electroporation of opened stomata, (E) Irreversible electroporation of epidermal cells, (F) Vacuum impregnation with trehalose before PEF treatment with PEF parameters as in D, (G) Vacuum impregnation of the control with trehalose was applied prior to drying. Data points are averages of three replications.

In FIG. 4 there is shown a table providing the weight after rehydrating to constant weight at room temperature for different treatments, which are: (A) The control, (B) reversibly electroporation with opened stomata not electroporated, (C) Reversible electroporation of opened stomata, (D) Irreversible electroporation of epidermal cells, (E) Vacuum impregnation with trehalose before PEF treatment with PEF parameters as in C, (F) Vacuum impregnation of the control with trehalose was applied prior to drying.

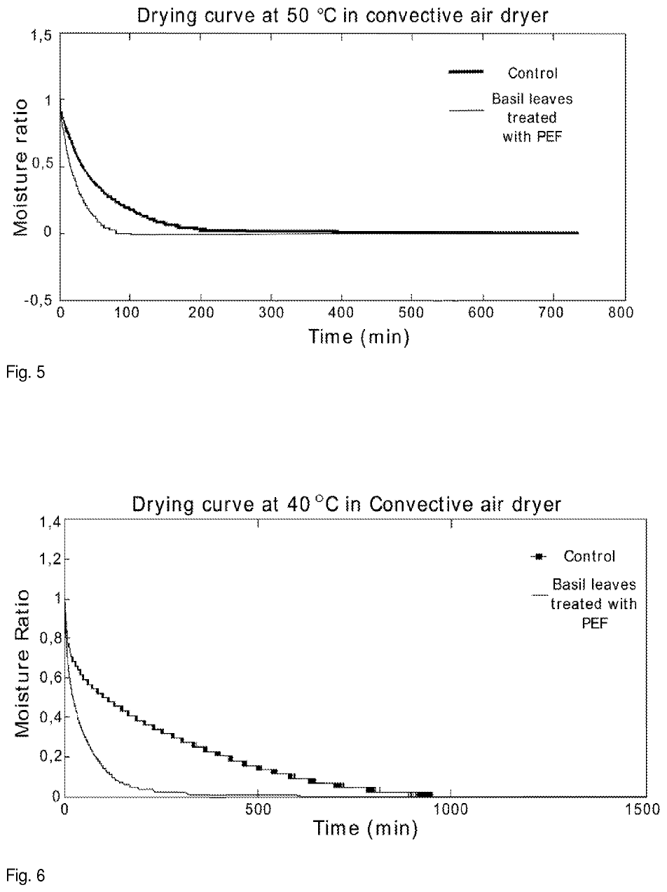

Furthermore, in FIG. 5 there is shown the drying curves at 50° C. convective air-drying of control (untreated) basil leaves and the effect of PEF treatment on the convective air-drying of basil leaves.

In FIG. 6 there is depicted the drying curves at 40° C. convective air-drying of control (untreated) basil leaves and the effect of PEF treatment on the convective air-drying of basil leaves.

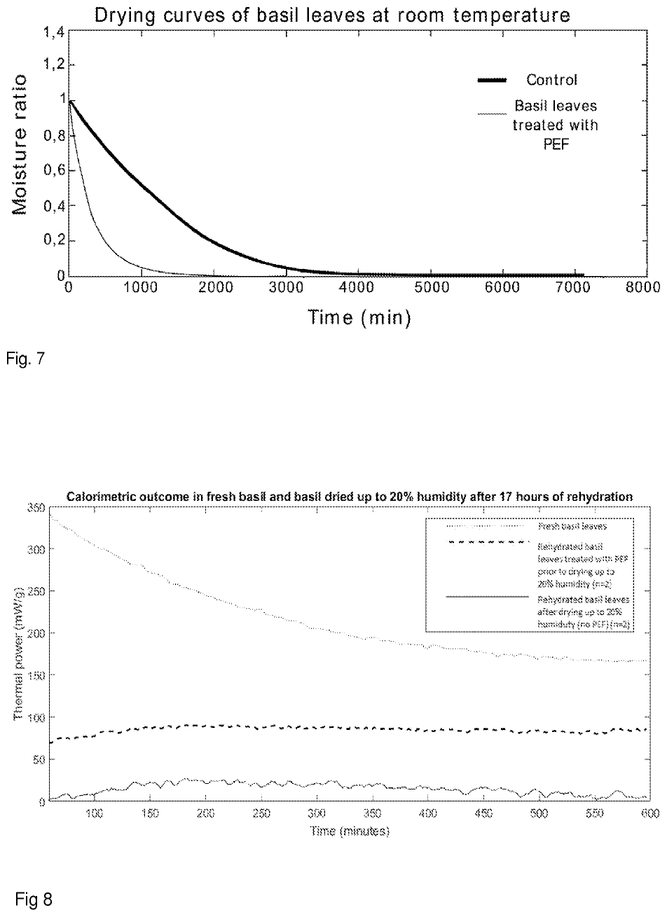

Moreover, in FIG. 7 there is shown the drying curves for room temperature of control (untreated) basil leaves and the effect of PEF treatment on the convective air-drying of basil leaves.

Furthermore, in FIG. 8 there is shown the calorimetric results of fresh PEF-treated and dried, untreated and dried basil leaves. (i) the upper curve corresponds to the fresh, untreated, non-dehydrated basil, (ii) Rehydrated basil leaves treated with PEF prior to drying up to 20% moisture content (iii) the last curve (close to 0) corresponds to the leaves that were dried without PEF treatment (untreated control). FIG. 8 shows the positive effect of maintaining the metabolic activity in the cells according to the present invention. Below there is provided yet another example where vacuum impregnation was used as a first step before a PEF step.

### PEF PARAMETERS AFTER VI

Below there is provided a suggested protocol for basil and dill. The protocol is as follows:

| | STEP | STEP | STEP | STEP | STEP | STEP | STEP | STEP | STEP | STEP |
|---|---|---|---|---|---|---|---|---|---|---|
| | 1 | 2 | 3 | 4 | 5 | 6 | 7 | 8 | 9 | 10 |
| Pressure (mbar) | 700 | 650 | 600 | 500 | 400 | 250 | 170 | 100 | 50 | 150 |
| Time (s) | 10 | 5 | 10 | 5 | 5 | 10 | 5 | 30 | 1 | 1 |
| Time 8 (min) | 0 | 0 | 0 | 0 | 0 | 0 | 0 | 0 | 1 | 1 |
| | STEP | STEP | STEP | STEP | STEP | STEP | STEP | STEP | STEP | STEP |
| | 11 | 12 | 13 | 14 | 15 | 16 | 17 | 18 | 19 | 20 |
| Pressure (mbar) | 250 | 300 | 350 | 400 | 450 | 500 | 550 | 600 | 700 | 1000 |
| Time (s) | 1 | 30 | 30 | 30 | 30 | 30 | 30 | 30 | 30 | 50 |
| Time 8 (min) | 1 | 0 | 0 | 0 | 0 | 0 | 0 | 0 | 0 | 1 |

The solution used for the impregnation of dill is 10 g/100 ml of trehalose. Basil is impregnated with isotonic trehalose solution (4.5 g/100 ml).

### Basil

The voltage in which basil presents stomata electroporated with no VI treatment is 0.6 kV/cm. After VI treatment, the voltage in which there is electroporation of stomata is 0.47 kV/cm. The rest of the PEF parameters is not changed (65 pulses, 150 μs of pulse width, 760 pulse space).

### Dill

The voltage in which dill presents stomata electroporated with no VI treatment is 1.0 kV/cm. After VI treatment, the voltage in which there is electroporation of stomata is 0.88 kV/cm. The rest of the PEF parameters is not changed (400 pulses, 100 μs of pulse width, 1000 μs pulse space).

### Metabolic Activity of Basil During Drying

Fresh (untreated) basil leaves metabolic activity was measured with calorimetry and it was compared with the treated (irreversible electroporation of stomata and reversible electroporated of other cells) and untreated basil leaves metabolic activity during drying process. The results show that PEF has irreversibly damaged the stomata and reversibly electroporated the other cells, keeping viability during the drying process.

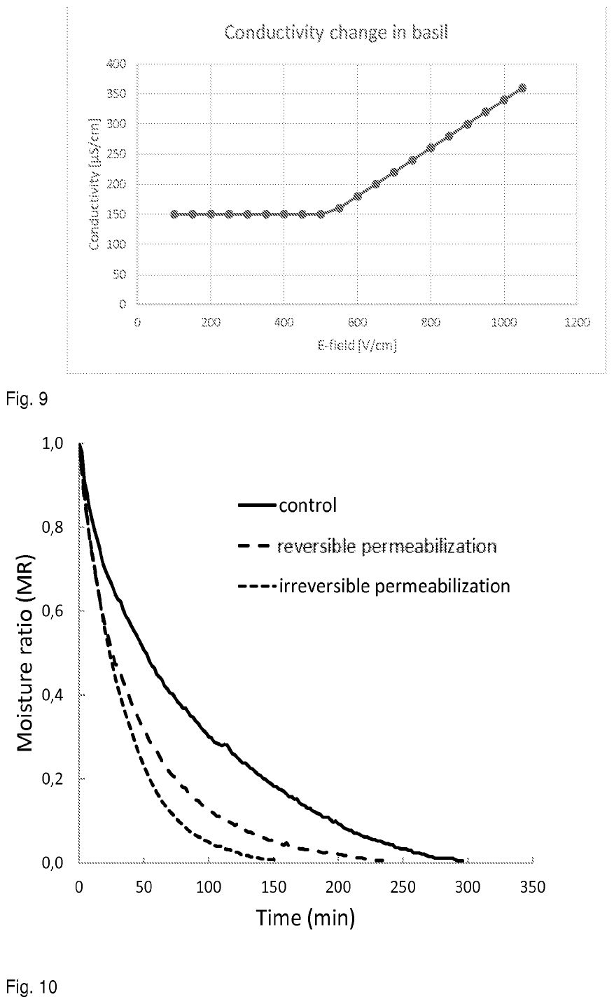

In FIG. 9 there is shown the conductivity change in basil. The conductivity increases in cells after electroporation has started. FIG. 9 shows the relationship between the conductivity and electrical field. In this case, electroporation starts at around 500 V/cm. The chosen electrical field to get the best survival shall be when the conductivity has increased with more than 5% between the first and the last pulse of the treatment. As may be understood from the graph, measuring the conductivity may be of interest to be utilized in a PEF treatment of biological soft tissue, such as according to one embodiment of the present invention. Furthermore, according to yet another embodiment of the present invention the conductivity is measured after a first pulse and after a last pulse, and wherein the applied field strength is selected so that the conductivity has increased at least 5% between the first pulse and the last pulse.

Furthermore, in FIG. 10 there is shown drying curves for reversible, irreversible electroporation and an untreated leaves (control). As disclosed above, the present invention is directed to a method involving PEF treatment to open up the stomata, and which PEF treatment is performed with reversible electroporation and a subsequent drying step. In FIG. 10 there is shown the drying curve for such treatment, but also drying curves for untreated control as well as irreversible electroporation, the latter two not being part of the scope of the present invention.

1. A method for treatment of biological soft tissue, said method comprising
a step involving pulsed electric field (PEF) treatment to open up the stomata in tissues by electroporation of guard cells and a subsequent drying step,
wherein the PEF treatment is performed in an electrical field with a field strength in the range of 0.4-1.5 kV/cm to provide enhanced rate of moisture removal during dehydration without irreversible damage on epidermal cells,
wherein the PEF treatment is performed with reversible electroporation and wherein the temperature in the drying step is held within the range of 20-55° C.

2. The method according to claim 1, wherein the stomata is kept open during the PEF treatment and during at least part of the subsequent drying step.

3. The method according to claim 2, wherein the stomata is kept open during the entire method.

4. The method according to claim 1, wherein the PEF treatment is performed so that the metabolic activity is kept when drying to at least a moisture level of 20% moisture content.

5. The method according to claim 1, wherein the drying step is maximum performed down to a moisture level of 20% moisture content to keep metabolic activity in the cells.

6. The method according to claim 1, wherein pulses applied have a field strength in the range of 0.4-1.0 kV/cm.

7. The method according to claim 6, wherein pulses applied are monopolar pulses having a field strength in the range of 0.6-1.0 kV/cm.

8. The method according to claim 1, wherein the method also comprises measuring the conductivity.

9. The method according to claim 8, wherein the conductivity is measured after a first pulse and after a last pulse, and wherein the applied field strength is selected so that the conductivity has increased at least 5% between the first pulse and the last pulse.

10. The method according to claim 1, wherein the pulse width being applied is in the range of 80-150 μs.

11. The method according to claim 1, wherein the pulse space being applied is in the range of 500-1000 μs.

12. The method according to claim 1, wherein the number of pulses being applied is in the range of 65-300 pulses.

13. The method according to claim 1, wherein the number of pulse trains is in the range of 1-10.

14. The method according to claim 1, wherein the temperature in the drying step is held within the range of 20-50° C.

15. The method according to claim 1, wherein the temperature in the drying step is held within the range of from room temperature to 40° C.

16. The method according to claim 1, wherein the drying is performed by convective air drying.

17. The method according to claim 1, wherein the method also involves a vacuum impregnation step.

18. The method according to claim 1, wherein the method involves a step of conservation of aroma in a herb.
